(19) United States
(12) Patent Application Publication
(10) Pub. No.: US 2022/0078185 A1
(43) Pub. Date: Mar. 10, 2022

(54) METHOD AND DEVICE FOR AUTHENTICATING IDENTITY INFORMATION, AND SERVER

(71) Applicant: XUNTENG (GUANGDONG) TECHNOLOGY CO., LTD., Guangzhou (CN)

(72) Inventors: Weiming Jian, Guangzhou (CN); Aiping Pi, Guangzhou (CN); Huagui Liang, Guangzhou (CN); Feiying Huang, Guangzhou (CN); Qiurong Chen, Guangzhou (CN)

(21) Appl. No.: 17/418,769

(22) PCT Filed: Dec. 13, 2019
(86) PCT No.: PCT/CN2019/125377

§ 371 Date: Jun. 25, 2021

(30) Foreign Application Priority Data
Dec. 26, 2018 (CN) 201811608040.9

(51) Int. Cl. H04L 29/06

(52) U.S. Cl. CPC H04L 63/0861

(57) ABSTRACT

This application provides an authenticating method for identity information, and device and server therefor, which relate to the technical field of identity authentication. The method is executed by a server, the server is respectively connected in communication to a target authentication device and a user terminal; the method comprises: receiving a first identity information of a user to be authenticated and identification information of the target authentication device sent by the target authentication device; performing a legality authentication on the first identity information of the user to be authenticated based on stored first identity information of a legal user and the identification information of the target authentication device; sending the authentication result to the target authentication device. This application may effectively protect personal identity information, improve security, reliability and convenience of identity authentication, and enhance user experience.

### CROSS-REFERENCES TO RELATED APPLICATIONS

This application claims priority of Chinese Patent Application No. CN201811608040.9, titled “An Authenticating Method for Identity Information, and Device and Server therefor”, filed with the Chinese Patent Office on 26 Dec. 2018, the entire content of which is incorporated by reference in this application.

### TECHNICAL FIELD

This application relates to the field of identity authentication technology, in particular to an authenticating method for identity information, and device and server therefor.

### TECHNICAL BACKGROUND

With the rapid development of network technology and the emergence of convenient methods such as mobile payment, carrying cash has gradually become history. In the near future, physical identification cards will also be replaced by existing technologies. One may go out conveniently without carrying a physical identification card, which will become a trend.

Identity authentication based on biometrics has been applied in many occasions, but the existing biometrics technology is subject to the influences by conditions such as shooting angle, shooting distance, light direction, light angle, light and dark, and light color etc., which cause large deviations in the face comparison results. Further, there may be two people who look exactly the same in the case of brothers, sisters, twins or persons not related by blood. Therefore, the reliability of biometrics technology needs to be improved.

Citizens' personal identity information belongs to personal privacy and is protected by law. No individual, group or business unit is allowed to save citizens' personal identity information. The illegal storage of personal identity information violates citizens' privacy rights and even leads to personal information leakage, which in turn leads to various social issues. Therefore, the security of identity authentication needs to be improved.

### SUMMARY OF THE INVENTION

In view of this, the purpose of this application is to provide an authenticating method for identity information, and device and server therefor, which may effectively protect personal identity information, improve the security, reliability and convenience of identity authentication to enhance user experience.

In order to achieve the foregoing objectives, the technical solutions adopted in the embodiments of the present application are as follows:

In a first aspect, an embodiment of the present application provides an authenticating method for identity information, characterized in that, the method is executed by a server, the server is respectively connected in communication to a target authentication device and a user terminal; the method comprises: receiving a first identity information of a user to be authenticated and identification information of the target authentication device sent by the target authentication device; wherein the first identity information of the user to be authenticated comprises current biometric characteristics of the user to be authenticated; the current biological characteristics comprise current facial characteristics: the identification information of the target authentication device comprises account information of the target authentication device and location information of the target authentication device; performing a legality authentication on the first identity information of the user to be authenticated based on stored first identity information of a legal user and the identification information of the target authentication device; sending the authentication result to the target authentication device.

With reference to the first aspect, an embodiment of the present application provides the first possible implementation manner of the first aspect, wherein before the receiving the first identity information of the user to be authenticated sent by the target authentication device, the above method further comprises: receiving location information of the user terminal sent by the user terminal; performing a dynamic rasterization processing on the location information of the user terminal to determine a raster where the location information of the user terminal is located.

With reference to the first possible implementation manner of the first aspect, an embodiment of the present application provides the second possible implementation manner of the first aspect, wherein the step of performing the legality authentication on the first identity information of the user to be authenticated based on the stored first identity information of the legal user and the identification information of the target authentication device comprises: performing a dynamic rasterization processing on the location information of the target authentication device to determine a raster where the location information of the target authentication device is located; using the raster where the location information of the target authentication device is located and a raster within a preset range of the raster where the location information of the target authentication device is located as target rasters; finding stored biometric characteristics of each user in the target rasters based on the stored first identity information of the legal user; matching the current biological characteristics of the user to be authenticated with found stored biological characteristics of each user, so as to perform the legality authentication on the first identity information of the user to be authenticated.

With reference to the second possible implementation manner of the first aspect, an embodiment of the present application provides the third possible implementation manner of the first aspect, wherein the step of matching the current biological characteristics of the user to be authenticated with the found stored biological characteristics of each users comprises: determining whether the current biological characteristics are biological characteristics of a living body; if yes, comparing the current biological characteristics of the user to be authenticated with the found stored biological characteristics of each user; if the comparing shows that similarities between a stored biological characteristics and the current biological characteristics are greater than a preset similarity threshold, determining an account corresponding to the stored biological characteristics with similarities greater than the preset similarity threshold as a current user account; if the comparing shows that similarities between a plurality of the stored biological characteristics and the current biological characteristic are greater than the preset similarity threshold, determining each user corresponding to each of the stored biological characteristics with similarities greater than the preset similarity threshold as a plurality of users to be authenticated; performing re-identification on the plurality of the users to be authenticated; wherein the identification comprises confirming a preset number of digits in an identification card and/or a biometric matching.

With reference to the third possible implementation manner of the first aspect, an embodiment of the present application provides the fourth possible implementation manner of the first aspect, wherein the user terminal of the user to be authenticated comprises a user account, and the user account of the user to be authenticated for re-identification is the current user account, and the above method further comprises: sending a request to the user terminal of the current user account to obtain a second identity information of the user; wherein the user terminal comprises the second identity information of the user, and the second identity information of the user comprises a user's name, an identification card number of the user and stored biometrics of the user; when receiving the second identity information of the user sent by the user terminal of the current user account, determining whether the user terminal is set to allow responding to the request; if yes, verifying a legitimacy of the second identity information; if the second identity information is verified to be legal, sending the second identity information to the target authentication device, and generating an identity authentication log; sending the identity information authentication log to the user terminal of the user account.

With reference to the fourth possible implementation manner of the first aspect, an embodiment of the present application provides the fifth possible implementation manner of the first aspect, wherein after sending the request to the user terminal of the current user account to obtain the second identity information of the user, the above method further comprises: verifying the legitimacy of the second identity information through the user terminal of the current user account; if the second identity information is legal, sending the second identity information to the server through the user terminal of the current user account.

With reference to the fourth possible implementation manner of the first aspect, an embodiment of the present application provides the sixth possible implementation manner of the first aspect, wherein the server is further connected in communication with an identity authentication system, and the above method further comprises: if the authentication of the identity information is a second identity authentication request, after verifying that the second identity information is legal, sending the second identity information to the identity authentication system; performing an identity verification on the second identity information through the identity authentication system to obtain an identity verification result; sending the identity verification result to the server through the identity authentication system; if the identity verification result contains information that the second identity information is legal, sending the second identity letter to the target authentication device, and generating an identity information authentication log; sending the identity authentication log to the user terminal of the user account.

With reference to the fourth possible implementation manner of the first aspect, an embodiment of the present application provides the seventh possible implementation manner of the first aspect, wherein the server is further connected in communication with an identity authentication system, and the above method further comprises: registering the second identity information on the user terminal through the identity authentication system.

With reference to the seventh possible implementation manner of the first aspect, an embodiment of the present application provides the eighth possible implementation manner of the first aspect, wherein the step of registering the second identity information on the user terminal through the identity authentication system comprises: receiving the second identity information sent by the user terminal; sending the second identity information to the identity authentication system; performing an identity verification on the second identity information through the identity authentication system; sending an identity verification result of the second identity information to the server through the identity authentication system; if the identity verification result contains information that the second identity information is legal, associating the stored biological characteristics of the user in the second identity information with the user account; sending the legal identity verification result of the second identity information to the user terminal; after receiving the legal identity verification result of the second identity information, the user terminal performs an encryption processing on the second identity information and saves the encrypted second identity information to the user terminal.

In a second aspect, an embodiment of the present application further provides an authentication device for identity information, the device is executed by a server, and the server is respectively connected in communication with a target authentication device and a user terminal; the device comprises: a receiving module configured to receive a first identity information of a user to be authenticated and identification information of the target authentication device sent by the target authentication device; wherein the first identity information of the user to be authenticated comprises current biometric characteristics of the user to be authenticated; the current biological characteristics comprise current facial characteristics; the identification information of the target authentication device comprises account information of the target authentication device and location information of the target authentication device; an authentication module configured to perform a legality authentication on the first identity information of the user to be authenticated based on stored first identity information of a legal user and the identification information of the target authentication device; a sending module configured to send the authentication result to the target authentication device.

With reference to the second aspect, an embodiment of the present application provides the first possible implementation manner of the second aspect, wherein the receiving module is configured to: receiving location information of the user terminal sent by the user terminal; performing a dynamic rasterization processing on the location information of the user terminal to determine a raster where the location information of the user terminal is located.

In a third aspect, an embodiment of the present application provides a server, comprising a processor and a memory; a computer program is stored on the memory, and when run by the processor, the computer program executes the method according to any one of the first aspect to the ninth possible implementation manner of the first aspect.

In a fourth aspect, an embodiment of the present application provides a chip with a program stored on the chip, when run by a processor, the program executes the steps of the method according to any one of the first aspect to the ninth possible implementation manner of the first aspect.

An embodiment of the present application provides an authenticating method for identity information, and device and server therefor, through receiving a first identity information of a user to be authenticated and identification information of the target authentication device sent by the target authentication device, performing a legality authentication on the first identity information of the user to be authenticated based on stored first identity information of a legal user and the identification information of the target authentication device to send the authentication result to the target authentication device. The identity information of the user to be authenticated comprises the current biological characteristics of the user to be authenticated, and the current biological characteristics comprise current facial features. The identification information of the target authentication device comprises account information of the target authentication device and the location information of the target authentication device. When the identity information of the user to be authenticated sent by the authentication device is authenticated, it comprises the authentication of the current biological characteristics in the identity information, and takes into account the influence of the target authentication device's identification information on the current biometric authentication, which may effectively protect personal identity information, improve security, reliability and convenience of identity authentication, and enhance user experience.

Other features and advantages of the present application will be described in the following description, and partly become obvious from the description or understood by implementing the present application. The purpose and other advantages of the application are realized and obtained by the structures specifically pointed out in the description, claims and figures.

In order to make the above-mentioned objectives, features and advantages of the present application more obvious and understandable, the preferred embodiments and accompanying figures are described in detail as follows.

### DESCRIPTION OF THE FIGURES

In order to more clearly illustrate the specific embodiments of the application or the technical solutions in the prior art, the following will briefly introduce the figures that need to be used in the description of the specific embodiments or the prior art. Obviously, the figures in the following description are some embodiments of the present application. For those of ordinary skill in the art, other figures may be obtained based on these figures without any inventive work.

FIG. 1 shows a flowchart of an authentication method for identity information provided by an embodiment of the present application;

FIG. 2 shows a flowchart of another authenticating method for identity information provided by an embodiment of the present application:

FIG. 3 shows a structural block diagram of an authentication device for identity information provided by an embodiment of the present application:

FIG. 4 shows an illustrative structural diagram of a server provided by an embodiment of the present application.

### EMBODIMENTS

In order to make the purpose, technical solutions and advantages of the embodiments of this application clearer, the technical solutions of this application will be described clearly and completely in conjunction with the accompanying figures. Obviously, the described embodiments are part of the embodiments of this application, not all of the embodiments. Based on the embodiments in this application, all other embodiments obtained by those of ordinary skill in the art without inventive work shall fall within the protection scope of this application.

The existing biometrics technology is subject to the influences by conditions such as shooting angle, shooting distance, light direction, light angle, light and dark, and light color etc., which cause large deviations in the face comparison results. Further, there may be two people who look exactly the same in the case of brothers, sisters, twins or persons not related by blood. Therefore, the reliability of biometrics technology needs to be improved. Citizens' personal identity information belongs to personal privacy and is protected by law. No individual, group or business unit is allowed to save citizens' personal identity information. The illegal storage of personal identity information violates citizens' privacy rights and even leads to personal information leakage, which in turn leads to various social issues. The security of identity authentication needs to be improved. Based on this, an authenticating method for identity information, and device and server therefor provided by the embodiments of the present application may effectively protect personal identity information, improve security, reliability, and convenience of identity authentication, and enhance user experience.

In order to facilitate the understanding of this embodiment, an authentication method for identity information disclosed in the embodiment of the present application is first introduced in detail.

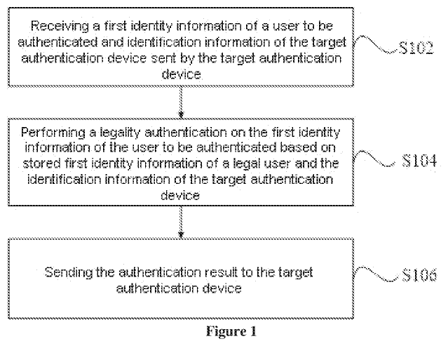

Referring to the flowchart of an authentication method for identity information shown in FIG. 1, the method is executed by a server such as a computer, the server is respectively connected in communication to a target authentication device and a user terminal, the method comprises the following steps:

Step S102: receiving a first identity information of a user to be authenticated and identification information of the target authentication device sent by the target authentication device; wherein the first identity information of the user to be authenticated comprises current biometric characteristics of the user to be authenticated; the current biological characteristics comprise current facial characteristics; the identification information of the target authentication device comprises account information of the target authentication device and location information of the target authentication device.

The target authentication device may be a self-service terminal (e-government self-service terminal, e-bank self-service terminal, electronic tax self-service terminal, hotel check-in self-service terminal, ATM (Automatic Teller Machine) machine, queuing machine, number picking machine, self-service printing machine, self-service invoice machine, self-service ticket collection machine and self-service settlement machine etc.), a shared device, a smart robot, a smart car, a drone, an identity authentication machine, a member and VIP identification device, a smart access control, an identity authentication equipment such as an intelligent video intercom equipment and an intelligent gate etc.

In addition to mobile phones, the user terminal may also be a personal mobile device such as a notebook computer, a tablet computer, a smart watch, a smart bracelet, a smart glass, a smart earplug, and a smart button-type device etc.

Biological characteristics comprise one or multiple of facial biometrics, iris biometrics, scleral biometrics, eye print biometrics, palm vein biometrics, palm print biometrics, finger vein biometrics, ear print biometrics, and voice print biometrics.

When the biological characteristics are facial characteristics, the current biological characteristics of the user to be authenticated are facial biometrics, comprising: a human face biological characteristic or a human face biological characteristic combined with facial expression information.

When the biological characteristics are facial characteristics, the current biological characteristics stored by the user are facial biometrics, comprising: a face biological characteristic, a face biological characteristic combined with facial expression information, a human face biological characteristic, or a human face biological characteristic combined with facial expression information.

One or more positioning technologies, BDS (BeiDou Navigation Satellite System), GPS (Global Positioning System), LBS (Location Based Service). AGPS (Assisted Global Positioning System), GSM (Global System for Mobile communications). IP (Internet Protocol) address positioning and WIFI (Wireless Fidelity), etc. may be set manually for location positioning to obtain the location information of the target authentication device.

For example, when a user picks up a ticket at a high-speed railway station at the self-service terminal of the high-speed railway station, if the user needs to use the self-service terminal to handle the ticket collection service, the user is a user to be authenticated, and the user to be authenticated needs to be authenticated to proceed with the next step of business processing. The user to be authenticated may operate according to the prompt information provided by the interactive interface of the target authentication device. For example, if the option to collect biometrics is selected, the target authentication device may collect the user's current biometrics, such as current facial characteristics, including current human facial characteristics and/or current human facial characteristics combined with the facial expression information of the human body. The above-mentioned information collected by the target authentication device is used as the first identity information of the user to be authenticated, and the first identity information of the user to be authenticated is sent to the server through the target authentication device.

Step S104: performing a legality authentication on the first identity information of the user to be authenticated based on stored first identity information of a legal user and the identification information of the target authentication device.

The server stores the identity information of legal users, including stored biometrics. Legal users include users who have passed the authentication of the Ministry of Public Security through the user information entered on the user terminal. These authenticated users store the biometric characteristics of the input user terminal and the identification information of the user terminal in the user terminal and send them to the server by the user terminal for storing in the server. The server may also obtain the location information of the target authentication device sent by the target authentication device, and dynamically rasterize the location information of the target authentication device to determine the raster where the location information is located. According to the raster where the location information of the target authentication device is located, the location of the user corresponding to the legal user's identity information stored in the server is determined to conform to a preset raster range. The server compares the identity information of the user to be authenticated with the identity information of the user conforming to the preset raster range to determine the legitimacy of the identity information of the user to be authenticated.

One or more positioning technologies, such as BDS, GPS, LBS, AGPS. GSM. IP. WIFI, and gyroscope positioning, may be used for location positioning to obtain the location of the user.

Step S106: sending the authentication result to the target authentication device.

After the server determines the legitimacy of the identity information of the user to be authenticated, it sends the authentication result to the target authentication device. If the authentication result contains information that the identity information of the user to be authenticated is legal, the user to be authenticated passes the authentication, and the target authentication device allows the user to be authenticated to perform the next step of business handling operations. If the user to be authenticated fails to pass the authentication, the target authentication device does not allow the user to be authenticated to perform subsequent operations.

For example, when a user picks up a ticket through a self-service terminal at a high-speed rail station, at this time, the self-service terminal of the high-speed rail receives the authentication result from the server. If the authentication result contains legal information such as the name and identification card number of the user to be authenticated, the user to be authenticated is authenticated. The self-service processing terminal allows the user to perform the next step of the ticket collection operation; at this time, the business processing terminal obtains the legal identity information of the user, which achieves the effect equivalent to a machine-readable physical identification card, and performs “real-name, real-person and real evidence” certification results. If the user to be authenticated fails to pass the authentication, the self-service terminal does not allow the user to perform subsequent ticket collection operations.

The above-mentioned authentication method for identity information provided by the embodiment of the present application receives the first identity information of the user to be authenticated sent by the target authentication device, and based on the stored first identity information of the legal user and the identification information of the target authentication device, the first identity information of the user to be authenticated is legally verified, thereby sending the authentication result to the target authentication device. The first identity information of the user to be authenticated includes the current biometrics of the user to be authenticated, and the current biometrics includes the current facial characteristics. The identification information of the target authentication device includes the account information of the target authentication device and the location information of the target authentication device. Since the server authenticates the identity information of the user to be authenticated sent by the target authentication device, it includes authenticating the current biometrics in the identity information, and takes into account the influence of the target authentication device's identification information on the current biometric authentication, which may effectively protect personal identity information, improve security, reliability and convenience of identity authentication, and enhance user experience.

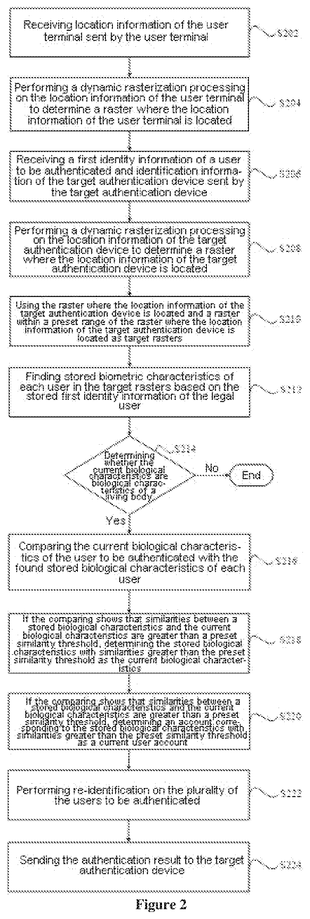

For ease of understanding, another authentication method for identity information based on this embodiment is given below. Referring to the flowchart of an authentication method for identity information as shown in FIG. 2, the method includes the following steps:

Step S202: receiving location information of the user terminal sent by the user terminal.

Step S204: performing a dynamic rasterization processing on the location information of the user terminal to determine a raster where the location information of the user terminal is located.

According to the dynamic raster management technology, the raster where the received position information of the user terminal is located may be determined.

Step S206: receiving a first identity information of a user to be authenticated and identification information of the target authentication device sent by the target authentication device; wherein the first identity information of the user to be authenticated comprises current biometric characteristics of the user to be authenticated; the current biological characteristics comprise current facial characteristics; the identification information of the target authentication device comprises account information of the target authentication device and location information of the target authentication device.

The target authentication device includes a camera, and the current biological characteristics of the user to be authenticated are collected through the camera of the target authentication device.

If the target authentication device pre-stores a living body biological characteristic determination method, the living body biological characteristic determination method is used to determine whether the current biological characteristic of the user to be authenticated is alive; if it is judged to be non-living, the target authentication device does not send the user's first identity Information and identification information of the target authentication device to the server.

Step S208: performing a dynamic rasterization processing on the location information of the target authentication device to determine a raster where the location information of the target authentication device is located.

According to the dynamic raster management technology, the server performs dynamic rasterization processing on the location information of the target authentication device, and determines the raster where the location information of the target authentication device is located.

Step S210: using the raster where the location information of the target authentication device is located and a raster within a preset range of the raster where the location information of the target authentication device is located as target rasters.

The preset range may be pre-stored in the server, and the server determines the target raster according to the pre-stored preset range.

Step S212: finding stored biometric characteristics of each user in the target rasters based on the stored first identity information of the legal user.

The server searches for user terminals whose locations are in the target raster, and searches the stored biological characteristics of each user corresponding to each user terminal in the target raster according to the searched user terminals.

Step S214: determining whether the current biological characteristics are biological characteristics of a living body; if so, step S216 is executed; if not, ends.

The current biological characteristics may be determined according to the method for determining the biological characteristics of the living body stored in advance.

Step S216: comparing the current biological characteristics of the user to be authenticated with the found stored biological characteristics of each user.

Step S218: if the comparing shows that similarities between a stored biological characteristics and the current biological characteristics are greater than a preset similarity threshold, determining the stored biological characteristics with similarities greater than the preset similarity threshold as the current biological characteristics.

If only one of the user's stored biological characteristics in the target raster has similarities with the current biological characteristics greater than the preset similarity threshold, it means that there is one and only one biometric among the user's stored biological characteristics in the target raster may be matched with the current biological characteristics, and the biological characteristic whose similarities are greater than the preset similarity threshold is determined as the current biological characteristic.

Step S220: if the comparing shows that similarities between a stored biological characteristics and the current biological characteristics are greater than a preset similarity threshold, determining an account corresponding to the stored biological characteristics with similarities greater than the preset similarity threshold as a current user account.

Step S222: performing re-identification on the plurality of the users to be authenticated; wherein the identification comprises confirming a preset number of digits in an identification card and/or a biometric matching.

It may be that the server sends a reminder to the target authentication device to confirm the identity again, and the target authentication device prompts the user to be authenticated to re-identify according to the reminder sent by the server, such as prompting the user to be authenticated to enter the number of preset digits in the identification card and/or input mobile phone number, perform biometric confirmation of iris, sclera, finger vein, palm vein, palm print, eye print, ear print, voice print, etc., to confirm that the account corresponding to the biometric characteristics whose similarities are greater than the preset similarity threshold is the current user account.

In one embodiment, the server sends a request to the user terminal of the current user account to obtain the user's second identity information; wherein the user terminal has the user's second identity information, and the user's second identity information includes the user's name, the user's second identity information, and identification number and biometrics that the user has stored. When the server receives the user's second identity information sent by the user terminal of the current user account, it determines whether the user terminal is set to allow responding to the request, and verifies the validity of the second identity information. If the user terminal is allowed to respond to the request and the second identity information is legal, the server sends the second identity information to the target authentication device and generates an identity authentication log through the server, and the server sends the identity information authentication log to the user terminal of the user account.

Specifically, after the server sends a request to the user terminal of the current user account for obtaining the second identity information of the user, the user terminal of the current user account verifies the legitimacy of the second identity information; if the second identity information is legal, the second identity information is sent to the server through the user terminal of the current user account.

In an embodiment, the server is also connected in communication with the identity authentication system, the above method further comprises: registering the second identity information of the user terminal through the identity authentication system, the server receives the second identity information sent by the user terminal, sending the second identity information to the identity authentication system; performing identity verification on the second identity information through the identity authentication system, and sending the identity verification result of the second identity information to the server; if the identity verification result contains information that the second identity information is legal, the server associates the user biometrics in the second identity information with the user account, and sends the identity verification result that the second identity information is legal to the user terminal; after the user terminal receives the identity verification result that the second identity information is legal, it encrypts the second identity information and saves the encrypted second identity information to the user terminal. The aforementioned encryption processing may be a preset encryption method, and the second identity information is encrypted according to the preset encryption method.

Step S224: sending the authentication result to the target authentication device.

If the authentication result contains information that the user to be authenticated passes the authentication, the target authentication device allows the user to be authenticated to perform the next step of business handling operations; if the user to be authenticated does not pass the authentication, the target authentication device does not allow the user to be authenticated to perform subsequent operations.

In one embodiment, before the user uses the target authentication device for identity authentication, the user needs to download the corresponding APP on the user terminal, install and open it; register in the APP, and obtain a users unique identification number, that is, the above identification information of the user terminal; click on the identification card information entry page, enter name and ID number etc. (specifically the interface requirements of the Public Security Department); enter personal photo image information, which may be static images, live images and live biological characteristics; The Public Security Department's identity authentication interface specification sends the user's name, ID number and personal photo image information to the identity authentication interface for identity authentication; if the authentication is passed, the above personal photo image information is associated with the user's unique ID number and saved in the server database; the authenticated message is sent to the user APP, and the APP encrypts the user's unique ID number and the user's name, ID number, personal photo and image information and other information, and perform encryption processing and save the encrypted information after encryption processing in the storage unit of the user terminal. The storage unit may be a file, a database, a dedicated chip etc.; the hardware ID information of the user terminal is added to the encrypted information to prevent tampering.

Further, if the identity authentication interface uses the identity authentication interface provided for the network ID card CTID, the user's unique CTID code may be downloaded and saved in the user terminal; if the local device uses the electronic ID card eID, the hardware information of the eID may be bound and stored in the user terminal; the user may click “authorize” or “unauthorized” in the authorization options of the APP to determine whether the user's identity information is allowed to be read; in the above process, the server only stores the user's face information and the user's unique ID number, that is, the above-mentioned biological characteristics and user terminal identification information are stored in the server, but the user's name, ID number and other personal identification information are not stored.

The server determines the user account of the user to be authenticated, which is the identification information of the aforementioned user terminal, and sends the user account to the APP of the user terminal to request the user's identity information; after receiving the request, the APP of the user terminal first determines whether the user has authorized the permission to read the identity information; then determines whether the user has complete identity information; then determines whether the identity information stored in the user terminal is legal, including: determining whether the information has been tampered with, determining whether the unique ID number of the user is consistent and whether it is consistent with the hardware ID information of the user terminal. If the user has authorized the authority to read the identity information and the identity information of the user terminal is legal, the APP sends the identity information of the user terminal to the server. If the above-mentioned user terminal adopts the electronic ID card eID, it is determined whether it is consistent with the hardware information bound to the eID.

After the server receives the identity information of the user terminal sent by the APP, it first determines whether the user's unique ID number is consistent, and then determines whether the personal photo image information is consistent. For general services (for example, identity authentication for entering a residential area and queuing for number collection etc.), the server may directly send the user's identity information to the target authentication device to complete the identity authentication and identity information acquisition operation, and generate the identity authentication record and send the generated identity authentication record to the APP of the user terminal; for services with a higher security level (for example, entry and exit identity authentication and ATM machine withdrawals without bank cards etc.), the server needs to perform secondary identity authentication, then send the user's name, ID number, and on-site photos taken by the self-service terminal, that is, the above-mentioned current biological characteristics (the specific content is determined by the identity authentication interface specification) to the identity authentication interface for identity authentication. If the secondary identity authentication is passed, then send the user's identity information to the target authentication device to complete the identity authentication and identity information acquisition operation, and generate the identity authentication record and send the generated identity authentication record to the APP of the user terminal, wherein if the identity authentication interface provided by the network ID card CTID is used, and the user information contains the user's unique CTID code, the user's CTID code and the on-site photo taken by the self-service terminal will be sent during the second identity authentication. The above-mentioned current biological characteristics (the specific content is determined according to the identity authentication interface specification) are sent to the corresponding identity authentication interface to determine whether the secondary identity authentication is passed.

In summary, in the above-mentioned identity information authentication method provided by the embodiments of the present application, the identity information of the user to be authenticated comprises the current biological characteristics of the user to be authenticated, and the current biological characteristics comprise the current facial characteristics, and the identification information of the target authentication device comprises the account information of the target authentication device and the location information of the target authentication device. Since the server authenticates the identity information of the user to be authenticated sent by the target authentication device, it authenticates the current biometrics in the identity information of the user to be authenticated according to the raster where the location information of the target authentication device is located, and taking into account of the influence of the identification information of the target authentication device on the current biometric authentication, the rasterization technology effectively reduces the number of biometric comparisons and speeds up the comparison, and reduces the investment in hardware equipment, effectively improve the accuracy of biometric comparison and the security of identity authentication; taking into account the security and legality of personal information, save their personal information through the user's device, and pass the legal verification of the identity information to prevent tampering, which protects personal identity information effectively; realize the reliability of identity authentication through the authority of the identity authentication system of the Public Security Department; based on this, users may achieve the same effect as a machine-readable physical identification card without carrying a physical ID card, and complete the identity verification of “real name, real person and real evidence” to improve the convenience of travel and realizes the convenience of identity authentication; further, because there is no need to take out physical identification cards and mobile phones and other physical objects, there is also no need to enter the ID number and mobile phone number and other operations, and the effect of the machine-readable ID card is directly completed through biometrics, which effectively enhances the user experience.

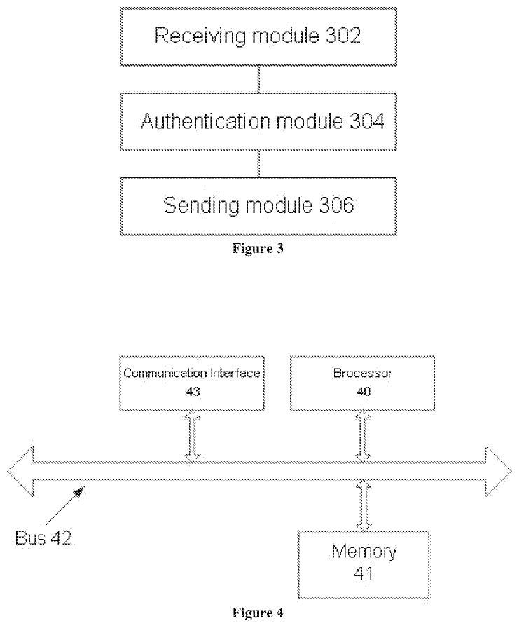

Corresponding to the aforementioned identity information authentication method, an embodiment of the present application provides an authentication device for identity information. Referring to the structural block diagram of an authentication device for identity information shown in FIG. 3, the device is executed by the server, and the server is respectively connected in communication to the target authentication device and the user terminal, and the device comprises the following modules:

a receiving module 302 configured to receive a first identity information of a user to be authenticated and identification information of the target authentication device sent by the target authentication device; wherein the identity information of the user to be authenticated comprises current biometric characteristics of the user to be authenticated; the current biological characteristics comprise current facial characteristics; the identification information of the target authentication device comprises account information of the target authentication device and location information of the target authentication device;

an authentication module 304 configured to perform a legality authentication on the first identity information of the user to be authenticated based on stored first identity information of a legal user and the identification information of the target authentication device;

a sending module 306 configured to send the authentication result to the target authentication device.

In the above-mentioned authentication device for identity information provided by the embodiment of the present application, the identity information of the user to be authenticated comprises the current biometric characteristics of the user to be authenticated, and the current biometric characteristics comprise the current facial characteristics, and the identification information of the target authentication device comprises the account of the target authentication device. When the identity information of the user to be authenticated sent by the authentication device is authenticated, it comprises the authentication of the current biological characteristics in the identity information, and takes into account the influence of the target authentication device's identification information on the current biometric authentication, which may effectively protect personal identity information, improve security, reliability and convenience of identity authentication, and enhance user experience.

The receiving module 302 is further configured for: receiving location information of the user terminal sent by the user terminal; performing a dynamic rasterization processing on the location information of the user terminal to determine a raster where the location information of the user terminal is located.

The implementation principles and technical effects of the device provided in this embodiment are the same as those of the foregoing embodiments. For a brief description, for parts not mentioned in the device embodiment, reference may be made to the corresponding content in the foregoing method embodiments.

The embodiment of the present application provides a server. Referring to the illustrative structural diagram of a server shown in FIG. 4, the server comprises: a processor 40, a memory 41, a bus 42 and a communication interface 43. The processor 40 and the communication interface 43 are connected to the memory 41 through a bus 42; the processor 40 is configured to execute an executable module stored in the memory 41, such as a computer program.

The memory 41 may comprise a high-speed random access memory (RAM), and may also include a non-volatile memory, such as at least one disk memory. The communication connection between the network element of the system and at least one other network element is realized through at least one communication interface 43 (which may be wired or wireless), and the Internet, a wide area network, a local network, a metropolitan area network etc. may be used.

The bus 42 may be an ISA bus, a PCI bus, an EISA bus etc. The bus may be divided into an address bus, a data bus, a control bus etc. For ease of presentation, only one bidirectional arrow is used to indicate in FIG. 4, but it does not mean that there is only one bus or one type of bus.

The memory 41 is configured to store a program, and the processor 40 executes the program after receiving the execution instruction. The method executed a device for the flow process definition disclosed in any of the foregoing embodiments of the present application may be applied to the processor 40 or implemented by the processor 40.

The processor 40 may be an integrated circuit chip with signal processing capability. In the implementation process, each step of the above method may be completed by an integrated logic circuit of hardware in the processor 40 or instructions in the form of software. The aforementioned processor 40 may be a general-purpose processor, including a central processing unit (CPU for short) and a network processor (NP) etc.; it may also be a digital signal processor (DSP for short). Application Specific Integrated Circuit (ASIC). Field-Programmable Gate Array (FPGA) or other programmable logic devices, discrete gates or transistor logic devices, and discrete hardware components to implement or execute the methods, steps, and logical block diagrams disclosed in the embodiments of the present application. The general-purpose processor may be a microprocessor or the processor may also be any conventional processor etc. The steps of the method disclosed in the embodiments of the present application may be directly embodied as being executed by a hardware decoding processor or by a combination of hardware and software modules in the decoding processor. The software module may be located in a mature storage medium in the field, such as a random access memory, a flash memory and/or a read-only memory, a programmable read-only memory, or an electrically erasable programmable memory and/or register. The storage medium is located in the memory 41. The processor 40 reads the information in the memory 41, and completes the steps of the above method in combination with its hardware.

The embodiment of the present application also provides a chip on which a program is stored, and the program is executed by the processor to execute the steps of any one of the foregoing embodiments.

Those skilled in the art may clearly understand that, for the convenience and conciseness of the description, the specific working process of the system described above may refer to the corresponding process in the foregoing embodiments, which will not be repeated here.

The authentication method for identity information, device, and server program product provided by the embodiments of the present application comprise a chip storing program code. The instructions included in the program code may be configured to execute the method described in the previous method embodiments. For specific implementation, the method embodiments may be referred to, which will not be repeated here.

If the function is implemented in the form of a software functional unit and sold or used as an independent product, it may be stored in a chip. Based on this understanding, the technical solution of the present application may be embodied in the form of a software product in essence or the part that contributes to the existing technology or the part of the technical solution. The software product is stored in a chip and comprises several instructions to enable a computer device (which may be a personal computer, a server, or a network device, etc.) to perform all or part of the steps of the methods described in the various embodiments of the present application.

Finally, it should be noted that the above-mentioned embodiments are only specific implementations of this application, which are used to illustrate the technical solution of this application, rather than limiting it. The scope of protection of the application is not limited to this, although the application has been described in detail with reference to the foregoing embodiments, and those of ordinary skill in the art should understand that any person skilled in the art familiar with the technical field within the technical scope disclosed in this application may still modify the technical solutions described in the foregoing embodiments or may easily think of changes or equivalently replace some of the technical features. However, these modifications, changes or replacements do not cause the essence of the corresponding technical solutions to deviate from the spirit and scope of the technical solutions of the embodiments of the present application, and should be covered within the protection scope of the present application. Therefore, the protection scope of this application should be subject to the protection scope of the claims.

1. An authenticating method for identity information, characterized in that, the method is executed by a server, the server is respectively connected in communication to a target authentication device and a user terminal; the method comprises:
receiving a first identity information of a user to be authenticated and identification information of the target authentication device sent by the target authentication device; wherein the first identity information of the user to be authenticated comprises current biometric characteristics of the user to be authenticated; the current biological characteristics comprise current facial characteristics; the identification information of the target authentication device comprises account information of the target authentication device and location information of the target authentication device;
performing a legality authentication on the first identity information of the user to be authenticated based on stored first identity information of a legal user and the identification information of the target authentication device;
sending the authentication result to the target authentication device.

2. The method according to claim 1, characterized in that, before the receiving the first identity information of the user to be authenticated sent by the target authentication device, the method further comprises:
receiving location information of the user terminal sent by the user terminal;
performing a dynamic rasterization processing on the location information of the user terminal to determine a raster where the location information of the user terminal is located.

3. The method according to claim 2, characterized in that, the step of performing the legality authentication on the first identity information of the user to be authenticated based on the stored first identity information of the legal user and the identification information of the target authentication device comprises:
performing a dynamic rasterization processing on the location information of the target authentication device to determine a raster where the location information of the target authentication device is located;
using the raster where the location information of the target authentication device is located and a raster within a preset range of the raster where the location information of the target authentication device is located as target rasters;
finding stored biometric characteristics of each user in the target rasters based on the stored first identity information of the legal user;
matching the current biological characteristics of the user to be authenticated with found stored biological characteristics of each user, so as to perform the legality authentication on the first identity information of the user to be authenticated.

4. The method according to claim 3, characterized in that, the step of matching the current biological characteristics of the user to be authenticated with the found stored biological characteristics of each users comprises:
determining whether the current biological characteristics are biological characteristics of a living body;
if yes, comparing the current biological characteristics of the user to be authenticated with the found stored biological characteristics of each user;
if the comparing shows that similarities between a stored biological characteristics and the current biological characteristics are greater than a preset similarity threshold, determining an account corresponding to the stored biological characteristics with similarities greater than the preset similarity threshold as a current user account;
if the comparing shows that similarities between a plurality of the stored biological characteristics and the current biological characteristic are greater than the preset similarity threshold, determining each user corresponding to each of the stored biological characteristics with similarities greater than the preset similarity threshold as a plurality of users to be authenticated;
performing re-identification on the plurality of the users to be authenticated; wherein the identification comprises confirming a preset number of digits in an identification card and/or a biometric matching.

5. The method according to claim 4, characterized in that, the user terminal of the user to be authenticated comprises a user account, and the user account of the user to be authenticated for re-identification is the current user account, and the method further comprises:
sending a request to the user terminal of the current user account to obtain a second identity information of the user; wherein the user terminal comprises the second identity information of the user, and the second identity information of the user comprises a user's name, an identification card number of the user and stored biometrics of the user,
when receiving the second identity information of the user sent by the user terminal of the current user account, determining whether the user terminal is set to allow responding to the request;
if yes, verifying a legitimacy of the second identity information;
if the second identity information is verified to be legal, sending the second identity information to the target authentication device, and generating an identity information authentication log;
sending the identity information authentication log to the user terminal of the user account.

6. The method according to claim 5, characterized in that, after sending the request to the user terminal of the current user account to obtain the second identity information of the user, the method further comprises:
verifying the legitimacy of the second identity information through the user terminal of the current user account;
if the second identity information is legal, sending the second identity information to the server through the user terminal of the current user account.

7. The method according to claim 5, characterized in that, the server is further connected in communication with an identity authentication system, and the method further comprises:
if the authentication of the identity information is a second identity authentication request, after verifying that the second identity information is legal, sending the second identity information to the identity authentication system;
performing an identity verification on the second identity information through the identity authentication system to obtain an identity verification result;
sending the identity verification result to the server through the identity authentication system;
if the identity verification result contains information that the second identity information is legal, sending the second identity information to the target authentication device, and generating an identity information authentication log;
sending the identity information authentication log to the user terminal of the user account.

8. The method according to claim 5, characterized in that, the server is further connected in communication with an identity authentication system, and the method further comprises:
registering the second identity information on the user terminal through the identity authentication system.

9. The method according to claim 8, characterized in that, the step of registering the second identity information on the user terminal through the identity authentication system comprises:
receiving the second identity information sent by the user terminal;
sending the second identity information to the identity authentication system;
performing an identity verification on the second identity information through the identity authentication system;
sending an identity verification result of the second identity information to the server through the identity authentication system;
if the identity verification result contains information that the second identity information is legal, associating the stored biological characteristics of the user in the second identity information with the user account;
sending the legal identity verification result of the second identity information to the user terminal;
after receiving the legal identity verification result of the second identity information, the user terminal performs an encryption processing on the second identity information and saves the encrypted second identity information to the user terminal.

10. An authentication device for identity information, characterized in that, the device is executed by a server, and the server is respectively connected in communication with a target authentication device and a user terminal; the device comprises:
a receiving module configured to receive a first identity information of a user to be authenticated and identification information of the target authentication device sent by the target authentication device; wherein the first identity information of the user to be authenticated comprises current biometric characteristics of the user to be authenticated; the current biological characteristics comprise current facial characteristics; the identification information of the target authentication device comprises account information of the target authentication device and location information of the target authentication device;
an authentication module configured to perform a legality authentication on the first identity information of the user to be authenticated based on stored first identity information of a legal user and the identification information of the target authentication device;
a sending module configured to send the authentication result to the target authentication device.

11. The device according to claim 10, characterized in that, the receiving module is configured to:
receiving location information of the user terminal sent by the user terminal;
performing a dynamic rasterization processing on the location information of the user terminal to determine a raster where the location information of the user terminal is located.

12. A server, characterized in that, comprising a processor and a memory;
a computer program is stored on the memory, and when run by the processor, the computer program executes the method according to claim 1.

13. A chip with a program stored on the chip, characterized in that, when run by a processor, the program executes the steps of the method according to claim 1.
